(19) United States
(12) Patent Application Publication
(10) Pub. No.: US 2026/0228550 A1
(43) Pub. Date: Aug. 6, 2026

(54) METHOD AND SYSTEM FOR AUTOMATED PROCESS OPTIMIZATION USING A MULTI-AGENT ARTIFICIAL INTELLIGENCE (AI) BASED OPTIMIZATION FRAMEWORK

(71) Applicant: LTI Mindtree Ltd, Mumbai (IN)

(72) Inventors: Anindita Desarkar, Mumbai (IN); Aritra Sen, Mumbai (IN); Vishwanathan Raman, Mumbai (IN); Ashish Varerkar, Mumbai (IN)

(21) Appl. No.: 19/226,202

(22) Filed: Jun. 3, 2025

(30) Foreign Application Priority Data
Feb. 5, 2025 (IN) 202521009528

(51) Int. Cl. G06N 3/092; G06F 8/10; G06F 8/41

(52) U.S. Cl. CPC G06N 3/092; G06F 8/10; G06F 8/443

(57) ABSTRACT

A method and system for automated process optimization using a multi-agent AI framework is disclosed. The multi-agent AI based optimization framework comprises AI agents that are configured to perform specific optimization-related operations. A domain identifier and prompt generation agent interfaces with an LLM to analyze input process documentation and identify optimization domains with corresponding optimization rationales. A formulator agent generates optimization problem specifications based on the identified optimization domains, and a programmer agent translates then into executable optimization code, and an evaluator agent validates optimization solutions and implement constraint adjustments. A supervisor agent operatively coupled to the plurality of AI agents, receives the input process documentation via an interface and orchestrates sequential interactions between the plurality of AI agents to generate and validate the optimization solutions, and presents the validated optimization solutions upon verifying the intermediate outputs.

### FIELD

Various embodiments of the present disclosure generally relate to process optimization. More particularly, the disclosure relates to a method and system for automated process optimization using a domain-agnostic multi-agent artificial intelligence (AI) based optimization framework driven by multiple AI agents to minimize user intervention.

### BACKGROUND

Process optimization is the practice of improving efficiency, reducing waste, and enhancing performance across various industries by systematically analyzing and refining workflows, resources, and decision-making strategies. In manufacturing, it involves optimizing production lines to minimize downtime and maximize output. In healthcare, it focuses on streamlining patient care and resource allocation to improve treatment outcomes. In logistics, it enhances route planning and inventory management to reduce costs and delivery times. Similarly, in finance and business operations, it ensures optimal resource utilization, compliance, and risk mitigation.

Irrespective of the industry, the process of identifying optimization opportunities from existing process manuals, formulating optimization problems, and deriving effective solutions remains a significant challenge. This is because it necessitates both deep domain expertise and a strong understanding of optimization methodologies. Finding professionals who possess both skill sets is not only difficult but also costly, making it a bottleneck for organizations striving for efficiency improvements. The complexity of analyzing unstructured process documentation, translating it into well-defined optimization problems, and developing executable solutions further compounds the challenge, often leading to inefficiencies, suboptimal decision-making, and increased operational costs.

Optimization modelling, despite its advantages, requires precise problem formulation, where decision variables, objective functions, and constraints must be accurately defined. This process often demands expertise in both the specific domain and mathematical optimization techniques, making it challenging for organizations to implement optimization on a scale. Furthermore, real-world processes are dynamic and involve uncertainties that traditional optimization models struggle to accommodate. As a result, manually developing and maintaining optimization models is time-consuming, labor-intensive, and prone to errors, limiting their practical application in complex and evolving business environments.

In some of the existing solutions, optimization problems are formulated manually from process manuals, which is both time-consuming and inefficient. This manual approach relies heavily on human expertise to interpret process documentation, extract relevant parameters, define decision variables, and establish constraints, often leading to inconsistencies and errors. Moreover, manual formulation lacks scalability, making it impractical for organizations dealing with complex, large-scale operations that require continuous optimization. As a result, businesses face delays in identifying and implementing process improvements, leading to suboptimal decision-making and increased operational costs.

Manual identification of key optimization constructs, such as decision variables, objective functions, and constraints, is often incomplete and non-exhaustive. Human analysts may overlook critical factors due to the complexity of process documentation, inherent biases, or a lack of comprehensive domain knowledge. Additionally, optimization problems in real-world scenarios are highly dynamic, with interdependent variables and evolving constraints that are difficult to capture manually. This limitation can result in suboptimal models that fail to accurately represent the problem space, leading to inefficient solutions that do not fully optimize the process. Consequently, organizations may miss potential improvements, incur higher costs, and struggle with operational inefficiencies.

Finding optimal solutions within the feasible region often requires iterative modifications to constraints, which, when done manually, is highly time-consuming and inefficient. Complex processes involve numerous interdependent constraints that must be continuously adjusted to refine the solution space and achieve optimal results. This manual adjustment process demands extensive domain expertise and repeated trial-and-error iterations, making it impractical for large-scale or dynamic optimization problems. Additionally, human-driven modifications can introduce biases or inconsistencies, leading to suboptimal outcomes.

Furthermore, while many industries are exploring the use of AI to identify optimization opportunities, most existing approaches rely on conventional AI models that primarily assist in data analysis and pattern recognition. However, these solutions often lack adaptability, autonomy, and the ability to iteratively refine optimization strategies. None of the existing solutions have leveraged multi-agent AI based optimization framework, which has the potential to operate autonomously, collaborate across multiple specialized AI agents, and dynamically adjust optimization parameters for more precise outputs.

Furthermore, some traditional Large Language Model (LLM)-based solutions exist that focus solely on mathematical formulation by extracting optimization models from a given problem statement and comparing results across different LLMs. However, these solutions are limited in scope as they do not provide a comprehensive, end-to-end framework for process optimization. They lack the capability to autonomously analyze unstructured process documentation, identify optimization opportunities, iteratively refine constraints, generate executable optimization code, and validate solutions in a real-world setting. Without a structured and orchestrated approach, these solutions remain fragmented, requiring significant human intervention to bridge the gaps between problem identification, formulation, execution, and validation.

Therefore, there is a need for a method and system that can provide an end-to-end solution for process optimization using a multi-agent AI framework which is driven by a network of specialized AI agents with deep understanding of the specific industry and the intricacies of existing processes along with strong foundation in optimization principles.

### SUMMARY

The present disclosure provides a method and system for automated process optimization using a multi-agent AI based optimization framework. The multi-agent AI based optimization framework includes a plurality of AI agents where each agent is configured to perform specific optimization-related operations. An identification agent interfaces with an LLM to analyze input process documentation and identify one or more optimization domains with corresponding optimization rationales. A formulator agent generates one or more optimization problem specifications comprising sets, parameters, decision variables, objective functions, and constraints based on the identified optimization domains. A programmer agent translates the optimization problem specifications into executable optimization code, and an evaluator agent validates optimization solutions and implements constraint adjustments. A supervisor agent operatively coupled to the plurality of AI agents, receives the input process documentation via an interface and orchestrates sequential interactions between the plurality of AI agents to generate and validate the optimization solutions. The supervisor agent verifies intermediate outputs at each processing stage and presents the validated optimization solutions via the interface.

### BRIEF DESCRIPTION OF THE FIGURES

FIG. 1 is a diagram that illustrates an exemplary environment within which various embodiments of the present disclosure may function.

FIG. 2 is a diagram that illustrates a system for automated process optimization using a multi-agent artificial intelligence (AI) based optimization framework, in accordance with an embodiment of the disclosure.

FIG. 3a-3e are diagrams that illustrate an exemplary embodiment for an automated supply chain process optimization using the multi-agent AI based optimization framework.

FIG. 4 is a flowchart that illustrates a method for automated process optimization using a multi-agent artificial intelligence (AI) based optimization framework, in accordance with an embodiment of the disclosure.

### DETAILED DESCRIPTION

Pursuant to various embodiments, the present disclosure provides a method and system for automated process optimization using a multi-agent AI based optimization framework. The multi-agent AI based optimization framework includes a plurality of AI agents where each agent is configured to perform specific optimization-related operations. An identification agent interfaces with an LLM to analyze input process documentation and identify one or more optimization domains with corresponding optimization rationales. A formulator agent generates one or more optimization problem specifications comprising sets, parameters, decision variables, objective functions, and constraints based on the identified optimization domains. A programmer agent translates the optimization problem specifications into executable optimization code, and an evaluator agent validates optimization solutions and implements constraint adjustments. A supervisor agent operatively coupled to the plurality of AI agents, receives the input process documentation via an interface and orchestrates sequential interactions between the plurality of AI agents to generate and validate the optimization solutions. The supervisor agent verifies intermediate outputs at each processing stage and presents the validated optimization solutions via the interface.

In one or more embodiments, the multi-agent AI framework refers to a specialized form of artificial intelligence where multiple intelligent agents operate autonomously, make decisions, and interact with one another to achieve a common objective. The multi-agent AI framework is characterized by its ability to function independently, adapt to changing environments, and autonomously refine their actions based on real-time data. Each agent in the multi-agent AI framework is designed to perform a specific role or task, leveraging deep domain knowledge and optimization principles. The AI agents collaborate and communicate with each other to solve complex problems, optimize processes, and iteratively adjust solutions without requiring constant human intervention.

In one or more embodiments, LLM is a type of AI model designed to process, understand, and generate human language. LLMs are built using deep learning techniques, specifically transformer architectures, and are trained on vast amounts of textual data. These models can perform a variety of language-related tasks, including text generation, question answering, translation, summarization, and information extraction.

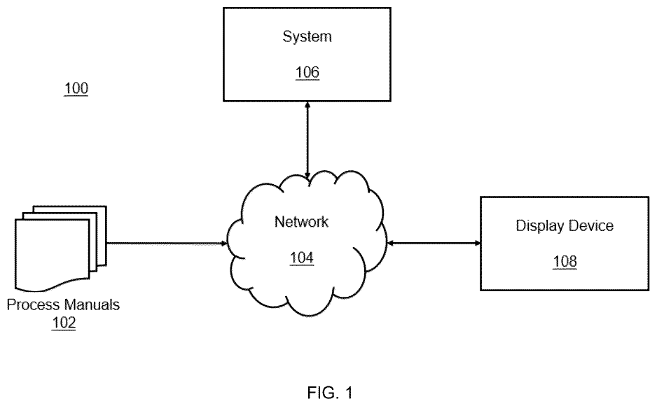

FIG. 1 is a diagram that illustrates an exemplary environment 100 within which various embodiments of the present disclosure may function. Referring to FIG. 1, the exemplary environment 100 may include process documents 102, a network 104, a system 106, and a display device 108.

The process documents 102 are comprehensive documents that outline the current workflows, operations, and procedures within an organization or system. These documents (manuals) contain detailed descriptions of the processes, decision points, rules, constraints, and objectives that govern how tasks are performed. They serve as a critical reference for understanding the structure and flow of operations and are often used to identify areas where optimization may be beneficial.

In an exemplary embodiment, the process documents 102 can be from any industry or domain such as, but not limited to, supply chain manuals, manufacturing operations manuals, healthcare protocols, financial transaction processes, logistics management guides, customer service workflows, and software development lifecycle documentation.

The network 104 facilitates communication between the various components of the environment 100, including the system 106 and display device 108. It enables the transfer of data, instructions, and results between the different agents and the user interface, allowing for seamless integration of the optimization process. The network 104 may comprise various communication protocols, such as local area networks (LAN), wide area networks (WAN), or the internet.

The system 106 is a domain-agnostic and user-agnostic multi-agent AI based optimization framework designed to automatically generate suggestions for process improvements, formulate optimization problems, and recommend actionable solutions. The system 106 is capable of operating across various industries without requiring customization specific to any one domain, making it highly adaptable and scalable. The multi-agent AI-based optimization framework comprises a set of specialized agents, each responsible for specific tasks within the optimization process. These tasks include identifying optimization areas within existing process documents, extracting and defining optimization constructs such as decision variables, objective functions, and constraints, generating executable optimization code, and providing feasible solutions based on the formulated optimization problem.

The system 106 is also designed with flexibility in mind, allowing for human feedback at every stage of the process. Users can interact with the system 106 to validate intermediate outputs, make adjustments to constraints or objectives, and refine the optimization results. This human-in-the-loop capability ensures that the final solution is more aligned with real-world conditions, domain-specific nuances, and user expectations, making the optimization process not only automated but also realistic and relevant to the actual operational environment.

The display device 108 provides a user with a visual interface to interact with the system 106. The display device 108 presents the results of the optimization process, including validated solutions, recommended adjustments, and any intermediate outputs. The user can use the display device 108 to monitor the progress of the optimization, review the outcomes, and make necessary adjustments to the process as needed.

In some non-limiting embodiments, the display device 108 can be any type of electronic device capable of presenting information to the user, including, but not limited to, a phone, desktop, laptop, tablet, or any other screen-equipped device that allows for visual interaction with the system 106.

In one or more embodiments, the display device 108 can be located on-premise or at a remote location, providing flexibility in how the user interacts with the system 106. The on-premise display device 108 may be situated within the organization's physical infrastructure, allowing for direct access to the system for employees or operators working on-site. On the other hand, the remote display device 108 enables the user to access the system from off-site locations, such as from home, satellite offices, or while traveling, through secure network connections.

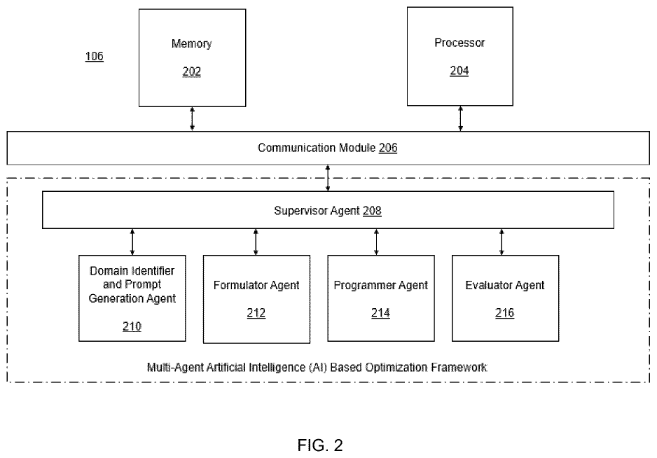

FIG. 2 is a diagram that illustrates the system 106 for automated process optimization using a multi-agent AI based optimization framework, in accordance with an embodiment of the disclosure. Referring to FIG. 2, the system 106 comprises a memory 202, a processor 204, a communication module 206, a supervisor agent 208, a domain identifier and prompt generation agent 210, a formulator agent 212, a programmer agent 214, and an evaluator agent 216.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 106 in accordance with various aspects of the present disclosure. The communication module 206 is configured to facilitate seamless interaction between the processor 204 and various modules within the system 106.

The supervisor agent 208 may include appropriate logic, code, and/or interfaces that is configured to coordinate and manage interactions among the plurality of AI agents within the multi-agent AI based optimization framework. It orchestrates the sequence of tasks, ensuring that each agent performs its designated function efficiently and in alignment with the overall optimization objective.

In one or more embodiments, the supervisor agent 208 acts as an orchestrator and is trained to oversee the flow of information and direct the execution of tasks across the plurality of AI agents. The supervisor agent 208 is equipped with coordination capabilities that allow it to manage the interdependence between agents, monitor their progress, and adjust task sequences as needed to optimize overall system 106 performance.

In one or more embodiments, each AI agent of the plurality of AI agents is configured to perform specific optimization-related operations, with each agent specializing in a distinct aspect of the overall process. The specialization of each agent enables that the optimization process is broken down into manageable tasks, allowing for a more efficient and targeted approach. Each agent is equipped with tailored capabilities and algorithms suited to its assigned function.

In one or more embodiments, the supervisor agent 208 is configured to receive the process documents 102 via an interface. Upon receiving the process documents 102, the supervisor agent 208 orchestrates sequential interactions between the plurality of AI agents to generate and validate the optimization solutions.

In one or more embodiments, the supervisor agent 208 is also configured to verify intermediate outputs at each processing stage of the plurality of AI agents. By performing the verification, the supervisor agent 208 ensures that the outputs produced by each AI agent are consistent with the expected results and meet the required standards. This step allows for the identification of any discrepancies or errors early in the process, enabling prompt adjustments to be made before progressing to the next stage.

In one or more embodiments, the supervisor agent 208 is further configured to present the intermediate outputs via the interface for optimal human validation. As the optimization process progresses, the supervisor agent 208 displays the intermediate outputs generated by the plurality of AI agents, including identification of optimization areas, problem formulations, generated code, and potential solutions, allowing the users to review, assess, and validate the outputs at each critical stage.

The supervisor agent 208 may receive human feedback, which can include modifications to several aspects of the process. The modifications may involve changes to the identified optimization domains, such as refining or broadening the areas of focus based on user expertise or domain knowledge. Additionally, users can provide feedback on the optimization problem specifications, adjusting key parameters such as decision variables, objective functions, or constraints to better reflect the actual operational conditions or business goals.

The human feedback may also extend to the executable optimization code, with users suggesting improvements or adjustments to ensure the code meets the practical requirements of the process. Furthermore, modifications can be made to the constraints within the optimization model, whether through relaxing, tightening, or adding new constraints based on real-world limitations or user preferences.

Once the human feedback is received, the supervisor agent 208 is responsible for propagating the modifications to subsequent processing stages, which ensures that any changes made are incorporated into the overall optimization flow, allowing the system 106 to adapt to new insights or requirements.

In one or more embodiments, the human feedback may include modifications to one or more of the identified optimization domains, the optimization problem specifications, the executable optimization code, and the constraint adjustments. This feedback supports in refining the optimization process to ensure its alignment with real-world requirements and user expectations. For example, the human feedback may suggest refining the identified optimization domains to capture additional relevant factors or remove irrelevant ones based on domain expertise. Similarly, the optimization problem specifications may be adjusted, with the user providing input on key parameters such as decision variables, objective functions, or constraints, ensuring they accurately represent the practical scenario.

Moreover, the human feedback may involve recommending changes to the executable optimization code to improve its efficiency, accuracy, or compatibility with the underlying system. This can include optimizing algorithms, modifying code logic, or enhancing the structure of the solution to ensure it meets specific performance criteria.

Additionally, the human feedback may involve adjusting the constraints of the optimization model, either by relaxing certain constraints to allow for more flexibility or tightening them to enforce stricter adherence to specific limitations. These modifications are vital for adapting the optimization process to the dynamic nature of real-world operations and ensuring that the generated solution is both feasible and effective.

Once the human feedback is received, the supervisor agent 208 is responsible for propagating the modifications to the subsequent processing stages. So that any changes made at earlier stages are carried forward and incorporated into the optimization workflow, allowing the system 106 to adapt in real-time. By integrating human input, the supervisor agent 208 helps refine the optimization process, enhancing its accuracy and ensuring that the final solution is optimized both from a computational perspective and according to practical business or operational needs.

The domain identifier and prompt generation agent 210 of the plurality of AI agents may comprise suitable logic, code, and/or interfaces is configured to interface with an LLM to analyze input process documentation received via the interface. Upon receiving the process documentation, the domain identifier and prompt generation agent 210 processes the text and extracts key information relevant to the optimization task. The LLM, which is capable of understanding and interpreting natural language, is utilized by the domain identifier and prompt generation agent 210 to identify one or more optimization domains.

Additionally, the domain identifier and prompt generation agent 210 works to identify the corresponding optimization rationales, which provide the reasoning behind selecting certain domains for optimization. This can include identifying inefficiencies, bottlenecks, or areas where resource allocation could be improved.

In one or more embodiments, the domain identifier and prompt generation agent 210 maintains a prompt library that comprises a collection of domain-specific optimization prompts. The prompt library is designed to cover a wide range of process domains, ensuring that the domain identifier and prompt generation agent 210 can tailor its analysis to the specific context of the input process documentation. Upon receiving the process documentation, the domain identifier and prompt generation agent 210 first analyzes the content to identify the underlying process domain, such as manufacturing, supply chain, healthcare, or finance. Based on the determined process domain, the domain identifier and prompt generation agent 210 retrieves the corresponding domain-specific optimization prompt from the prompt library.

An exemplary embodiment of the prompt library is implemented as a structured repository containing a diverse collection of domain-specific optimization prompts. Each prompt in the library is designed to address the unique characteristics and optimization challenges of a particular process domain. For example, the library may include dedicated prompts for industries such as manufacturing, supply chain management, healthcare, finance, logistics, and customer service.

An exemplary embodiment of the domain identifier and prompt generation agent 210 handling a wide range of process domains involves a scalable and adaptive framework that enables domain-specific optimization analysis across various industries and operational environments. The domain identifier and prompt generation agent 210 is equipped with intelligent domain classification capabilities and a dynamic prompt library that supports optimization across diverse process domains such as manufacturing, supply chain management, healthcare, finance, logistics, retail, customer service, energy management, and software development.

For instance, if the input documentation contains terms like “production schedule,” “machine downtime,” and “inventory levels,” the system 106 identifies the process domain as manufacturing. Alternatively, if the documentation includes references to “claim processing,” “billing codes,” and “insurance eligibility,” it is classified under healthcare administration.

In one or more embodiments, the domain-specific prompt is carefully engineered to include targeted instructions and context-relevant parameters that guide the subsequent analysis. The domain identifier and prompt generation agent 210 then transmits both the retrieved prompt and the original input process documentation to the LLM. The LLM processes the combined input, leveraging its advanced natural language understanding capabilities to perform an in-depth analysis of the process documentation in the context provided by the domain-specific prompt.

Following the LLM's analysis, the domain identifier and prompt generation agent 210 parses the responses to extract detailed information regarding potential optimization domains and the associated rationales. The rationale may include insights on inefficiencies, bottlenecks, or areas where improvements could yield significant benefits. By integrating a domain-specific prompt library, the domain identifier and prompt generation agent 210 enhances the precision of the optimization domain identification process also confirms that the extracted insights are both relevant and actionable for the targeted process area.

The formulator agent 212 may comprise suitable logic, code, and/or interfaces that may be configured to generate dynamic prompt and one or more optimization problem specifications comprising sets, parameters, decision variables, objective functions, and constraints based on the identified optimization domains and dynamic prompt.

In one or more embodiments, the formulator agent 212 receives the identified optimization domains and corresponding optimization rationale from the domain identifier and prompt generation agent 210. Upon receiving this information, the formulator agent 212 analyzes the characteristics of each optimization domain and translates them into a structured mathematical representation.

In some non-limiting embodiments, sets are the fundamental components of the optimization model, representing the elements over which decisions are made, such as time periods, resources, or process stages. Parameters are fixed numerical values that define the constraints and relationships in the model, such as resource availability, processing times, cost coefficients, and capacity limits. Decision variables are the variables that the optimization model seeks to determine, such as production levels, workforce allocation, or inventory quantities. These variables represent the choices available within the optimization framework. Objective functions are the mathematical expressions that define the optimization goals, such as minimizing costs, maximizing efficiency, improving throughput, or reducing waste. Constraints are the conditions that must be satisfied within the optimization problem, such as budget limitations, capacity restrictions, regulatory requirements, and time constraints.

In one or more embodiments, the formulator agent 212 receives the identified optimization domains and systematically extracts key optimization elements essential for problem formulation. The elements include sets, which define the fundamental components of the optimization model, such as time periods, resource groups, or process categories; parameters, which represent fixed numerical values derived from the input process documentation, such as capacity limits, cost coefficients, or operational thresholds; decision variables, which influence the optimization outcomes and encapsulate adjustable factors like production levels, staffing allocations, or scheduling decisions; objective functions, which define the optimization goals, such as minimizing costs, maximizing throughput, or enhancing resource utilization; and constraints, which impose limitations on the solution space, ensuring feasibility based on regulatory requirements, resource availability, or predefined business rules.

After extracting the elements, the formulator agent 212 determines the optimization type by analyzing the mathematical structure of the objective functions and the constraints. For instance, if the objective function and constraints are linear, the problem may be classified as a linear programming (LP) problem. If the constraints involve integer decision variables, it may be categorized as integer programming (IP), and if the optimization involves nonlinear relationships, it may fall under nonlinear programming (NLP). Additionally, the formulator agent 212 assesses whether the problem requires deterministic or stochastic optimization based on the presence of uncertainties in the process data.

Based on the determined optimization type, the formulator agent 212 selects an appropriate optimization solver from a set of available solvers. The selection may be based on factors such as the computational complexity of the problem, the required solution accuracy, and the processing time constraints. For instance, the solver may include commercial solvers such as, for example, Gurobi™, CPLEX™, and MOSEK™, or open-source solvers such as GLPK, CBC, and SCIP, depending on the nature of the problem and constraints. The selected solver is then configured to execute the formulated optimization model, ensuring that the generated solution aligns with the identified optimization goals.

In one or more embodiments, the formulator agent 212 is further configured to validate the mathematical completeness of the optimization problem specifications to ensure that all required components sets, parameters, decision variables, objective functions, and constraints are correctly defined and logically coherent. This validation process includes checking for missing dependencies, ensuring that all decision variables are properly bound, and confirming that constraints do not conflict with one another, which could otherwise lead to infeasible solutions.

Additionally, the formulator agent 212 verifies consistency between constraints by analyzing their structural relationships. This involves detecting redundant, contradictory, or overly restrictive constraints that might unnecessarily limit the feasible region of the optimization problem. The formulator agent 212 may also assess the dimensional consistency of parameters and variables to prevent formulation errors, such as mismatched units or misaligned indexing in multi-dimensional constraints.

Upon successful validation, the formulator agent 212 generates a structured representation of the optimization problem in a format suitable for code generation. This structured representation may include a formalized mathematical model expressed in symbolic notation, a standardized schema for representing the problem in a declarative optimization modeling language (e.g., AMPL™, Pyomo™, or GAMS™), or a structured data format such as JSON or XML, facilitating seamless transformation into executable code by the programmer agent 214. The structured representation ensures that the optimization problem can be efficiently parsed, translated into an appropriate programming framework, and executed using the selected optimization solver.

The programmer agent 214 may comprise suitable logic, code, and/or interfaces that may be configured to translate the optimization problem specifications into executable optimization code. The programmer agent 214 receives the structured representation of the optimization problem from the formulator agent 212 and maps the mathematical constructs such as sets, parameters, decision variables, objective functions, and constraints into a programming language or optimization modeling framework.

The programmer agent 214 is further configured to automatically select an appropriate programming environment based on the optimization type and solver requirements. For instance, if the optimization problem requires linear programming (LP), the programmer agent 214 may generate code in Python using PuLP™ or Gurobi™, whereas for mixed-integer programming (MIP), it may utilize Pyomo™ or CPLEX™. Similarly, for constraint programming or heuristic-based optimization, the programmer agent 214 may generate code compatible with frameworks like OR-Tools or MATLAB.

In an exemplary embodiment, the programming environment refers to the integrated ecosystem that supports software development, execution, and debugging. It includes programming languages, libraries, compilers, solvers, and runtime environments that enable efficient code execution. The selection of a programming environment depends on the problem domain, computational requirements, and optimization techniques being implemented.

In one or more embodiments, the programmer agent 214 receives the optimization problem specifications and selects appropriate optimization libraries based on the selected optimization solver. The selection of libraries is determined by the optimization type, computational complexity, and solver compatibility, ensuring efficient execution.

The programmer agent 214 then generates executable optimization code by systematically structuring it into key components. First, problem initialization routines are created to set up the computational environment, including library imports and solver configurations. Next, variable declarations are generated in alignment with the decision variables defined in the optimization problem specifications. The programmer agent 214 then formulates the objective function, ensuring that its implementation correctly reflects the optimization goal. Subsequently, constraint definitions are incorporated, preserving mathematical consistency and logical coherence within the solution space. The final component of the generated code includes solver integration interfaces, allowing seamless execution of the optimization problem within the designated solver framework.

In one or more embodiments, once the code is generated, the programmer agent 214 performs automated verification and validation to ensure correctness. This includes syntax checks, structural validation against the problem specifications, and preliminary test runs using sample data to detect potential errors.

In one or more embodiments, the programmer agent 214 structures the executable optimization code to handle one or more of data input validation, solution feasibility checks, error recovery mechanisms, and solution output formatting.

The data input validation component ensures that all input parameters, including sets, decision variables, constraints, and objective functions, conform to the expected format, range, and data type. The programmer agent 214 embeds automated checks to detect missing or inconsistent data, triggering corrective prompts or predefined fallback values as needed.

The solution feasibility checks involve incorporating verification routines to assess whether the computed optimization results satisfy all defined constraints and boundary conditions. If the solver returns an infeasible or suboptimal solution, the code includes mechanisms for constraint relaxation or parameter adjustments to refine the solution iteratively.

The error recovery mechanisms handle unexpected execution failures, such as solver convergence issues, numerical instability, or computational resource constraints. The programmer agent 214 integrates structured exception handling, logging mechanisms, and automated retries with adjusted parameters to enhance fault tolerance and ensure a higher probability of obtaining an optimal solution.

Finally, the solution output formatting ensures that the computed optimization results are structured in a readable and interpretable manner. The programmer agent 214 formats the output to align with predefined reporting standards, visual representation requirements, or integration with downstream decision-making systems.

The evaluator agent 216 may comprise suitable logic, code, and/or interfaces that may be configured to validate optimization solutions and implement constraint adjustments.

In one or more embodiments, the evaluator agent 216 executes the executable optimization code within a controlled environment to ensure stability and reproducibility of the optimization process. During execution, the evaluator agent 216 continuously monitors solution convergence by tracking key performance indicators such as objective function values, constraint satisfaction levels, and computational efficiency. If the solution fails to converge within predefined thresholds, the evaluator agent 216 analyzes the underlying causes, which may include infeasibility due to conflicting constraints, numerical instability, or suboptimal solver configurations.

Upon detecting infeasibility conditions, the evaluator agent 216 implements iterative constraint adjustments by dynamically modifying constraint boundaries, introducing relaxation factors, or restructuring penalty functions to guide the solution toward feasibility. These adjustments are informed by sensitivity analysis techniques, which assess how minor changes in constraints impact solution viability.

In one or more embodiments, implementing the iterative constraint adjustments includes a detailed process of identifying specific constraints that are causing infeasibility in the optimization process. The evaluator agent 216 analyzes the current optimization solution and identifies constraints that either conflict with other constraints or prevent the solution from reaching feasible regions of the solution space. This identification process may involve performing sensitivity analysis, where the impact of small changes in constraint parameters is evaluated to pinpoint the most influential constraints.

Once the infeasible constraints are identified, the evaluator agent 216 modifies the boundaries of these constraints within acceptable ranges, ensuring that the adjustments do not violate the overall optimization goals or predefined limits. The adjusted constraints are then integrated into the executable optimization code, and the code is re-executed with the updated constraint parameters.

After each adjustment iteration, the evaluator agent 216 verifies solution feasibility by re-assessing the satisfaction of all constraints. The feasibility check includes validating that the newly adjusted constraints do not introduce further infeasibility and that the solution converges toward an optimal solution. This process continues iteratively, with the evaluator agent 216 adjusting constraints as necessary and re-executing the optimization code, until a feasible solution that satisfies all constraints is found or the solution space is exhausted.

In one or more embodiments, the supervisor agent 208 receives the final, validated optimization results from the evaluator agent 216 and formats these results for clear presentation and integration into downstream applications or user workflows. The supervisor agent 208 may transform the solutions into various formats, such as graphical dashboards, structured reports (e.g., PDF, Excel, or JSON), or real-time notifications, depending on user preferences and system requirements. Additionally, the supervisor agent 208 is designed to support interactive visualizations, enabling the user to drill down into solution details, review constraint adjustments, and assess the performance metrics associated with the optimization outcomes.

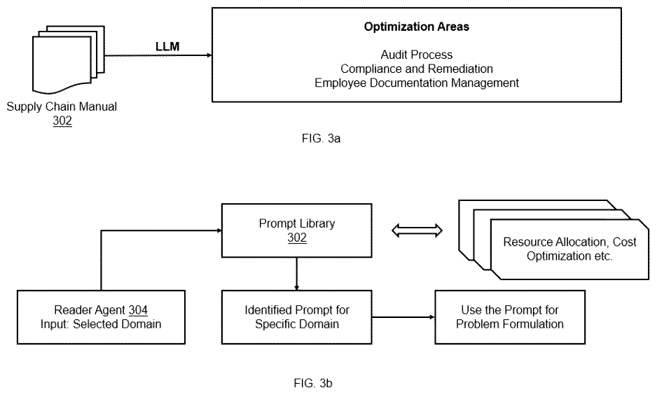

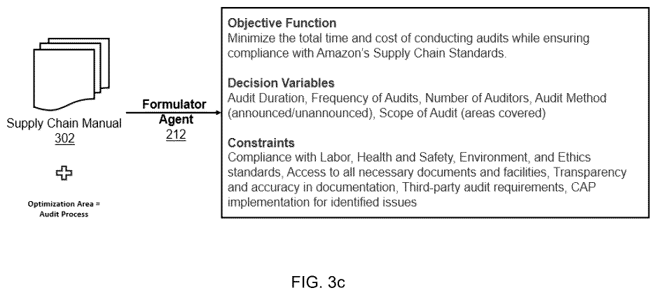

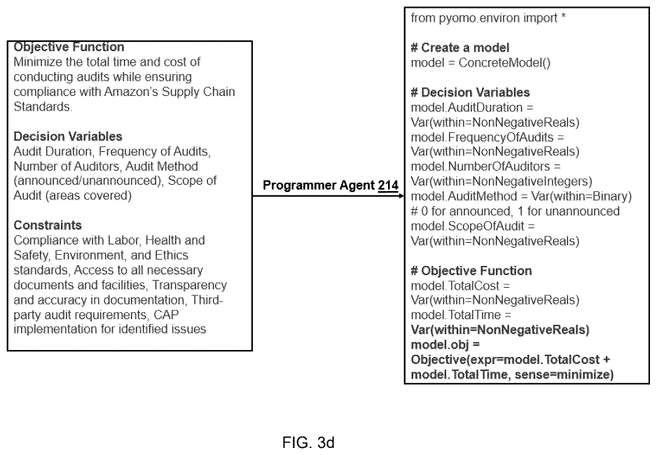

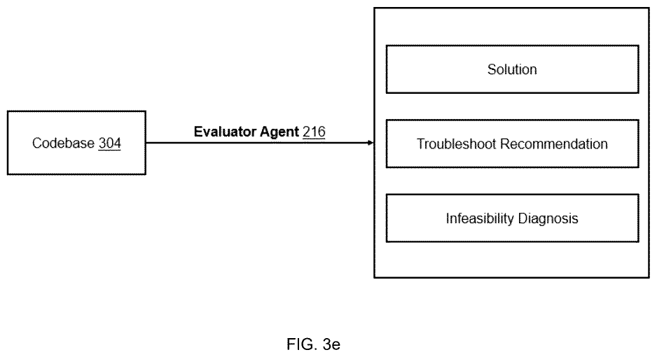

FIG. 3a-3e are diagrams that illustrate an exemplary embodiment for an automated supply chain process optimization using the multi-agent AI based optimization framework.

As illustrated in FIG. 3a, consider an e-commerce company, which maintains a supply chain manual 302 containing policies, procedures, and compliance requirements for suppliers and fulfillment centers. The company aims to optimize key operational areas, including audit process, compliance & remediation, and employee documentation management, to enhance efficiency, reduce costs, and ensure regulatory compliance.

The system 106 comprises the following agents:
Supervisor Agent 208—Oversees the entire process and ensures smooth coordination between the AI agents.
Domain identifier and prompt generation Agent 210—Extracts relevant optimization areas from the supply chain manual.
Formulator Agent 212—Constructs formal optimization problem specifications.
Programmer Agent 214—Generates executable optimization code.
Evaluator Agent 216—Executes and validates the optimization results.

The Supervisor Agent 208 initiates the optimization process by:
Receiving the supply chain manual as an input process documentation.
Assigning the domain identifier and prompt generation Agent 210 to analyze the input process documentation and extract relevant optimization areas.
Monitoring the process flow across all AI agents, ensuring that outputs from one agent seamlessly feed into the next.

The domain identifier and prompt generation Agent 210 utilizes a domain-specific prompt library and an LLM to analyze the supply chain manual. By applying natural language processing (NLP) techniques, it identifies three optimization areas:

### Audit Process Optimization

Prompt: Analyze the supply chain audit process provided. Identify inefficiencies in audit scheduling, resource allocation, and compliance verification. Suggest optimization areas that reduce audit duration, improve compliance rates, and enhance documentation transparency

### Compliance & Remediation Process Optimization

Prompt: Review the compliance and remediation framework outlined in the supply chain documentation. Identify bottlenecks in issue resolution, gaps in corrective action plans, and areas where automated tracking can improve regulatory adherence and supplier accountability

### Employee Documentation Management Optimization

Prompt: Examine the employee documentation processes, including onboarding, training records, and compliance verification. Identify inefficiencies in data retrieval, duplication in documentation workflows, and potential improvements using automation or optimized storage mechanisms.

The domain identifier and prompt generation agent 210 retrieves pre-defined domain-specific prompts for each area and transmits them to the LLM. The LLM responds with the optimization domains and their respective rationales.

For example, the LLM determines that the Audit Process optimization focuses on:
Reducing time and costs while ensuring compliance with company's Supply Chain Standards.

As illustrated in FIG. 3b, after the supervisor agent 208 assigns the domain identifier and prompt generation agent 210 to extract optimization areas, the system 106 dynamically generates prompts tailored to each domain using a structured approach.

The system 106 employs a three-step process to generate prompts for optimization:
A prompt library 302 is designed for various domains. A structured repository of domain-specific prompts is created, covering areas such as audit optimization, compliance & remediation, and employee documentation management.
A reader agent 304 is built to retrieve the specific prompt from the prompt library based on the domain identified by the domain identifier and prompt generation agent 210.
The specific prompt is utilized for optimization problem formulation. The retrieved prompt is then adapted to the optimization problem formulation phase. Since different domains require varied prompt structures, the system 106 confirms that the generated optimization problems are appropriately framed to address industry-specific constraints and objectives.

As illustrated in FIG. 3c, for each identified optimization area, the formulator agent 212 generates structured optimization problem specifications, including objective functions, decision variables, and constraints.

### Example: Audit Process Optimization

### Objective Function

Minimize the total time and cost of conducting audits while ensuring compliance with Amazon's Supply Chain Standards.

### Decision Variables

Audit Duration (hours per audit)
Frequency of Audits (per quarter)
Number of Auditors (internal/external)
Audit Method (announced/unannounced)
Scope of Audit (areas covered: labor, safety, environmental, ethics)

### Constraints

Must comply with Labor, Health & Safety, Environmental, and Ethical standards.
Must have access to all necessary documents and facilities.
Audit process must ensure transparency and accuracy in documentation.
Third-party audits must be conducted as per regulatory requirements.
A Corrective Action Plan (CAP) must be implemented for identified issues.

As illustrated in FIG. 3d, the programmer agent 214 receives the structured optimization problem specifications and generates executable optimization code. The programmer agent 214:
Selects the appropriate optimization library based on the problem type. (e.g., PuLP for linear programming or Gurobi for advanced constraint-solving).
Generates initialization routines, defining decision variables and constraints.
Implements the optimization logic, including:
   Cost and time minimization models.
   Constraint enforcement mechanisms.
Ensures robust execution handling, including:
   Data input validation (to prevent incorrect parameters).
   Solution feasibility checks (to verify compliance).
   Error recovery mechanisms (for infeasibility scenarios).
   Solution output formatting (for easy interpretation).

As illustrated in FIG. 3e, the evaluator agent 216 executes the generated optimization codebase 304 in a controlled environment and ensures that:
The solution converges with an optimal result.
All identified constraints are satisfied based on troubleshoot recommendation.
Infeasibility conditions (e.g., unrealistic constraints) are detected and adjusted iteratively, based on infeasibility diagnosis.

If infeasibility is detected, the evaluator agent 216 implements iterative constraint adjustments such as:
Modifying constraint boundaries (e.g., adjusting the required number of auditors).
Relaxing non-critical constraints to achieve feasible solutions.

After successful validation, the optimized audit process parameters (e.g., recommended number of audits per year, ideal number of auditors, cost-effective audit duration) are output for implementation.

The supervisor agent 208 formats the validated optimization results for review. The final output is presented via a user interface, allowing supply chain managers to:
Review optimized audit schedules and resource allocations.
Adjust constraints and re-run optimizations if needed.
Implement the optimized audit process in the company's operations.

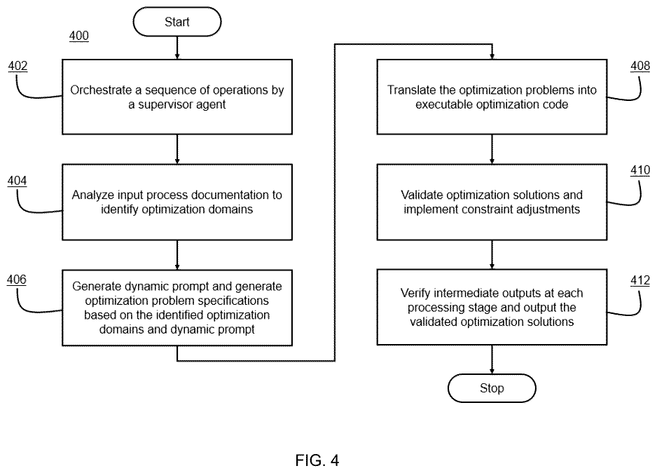

FIG. 4 is a flowchart 400 that illustrates a method for automated process optimization using a multi-agent artificial intelligence (AI) framework, in accordance with an embodiment of the disclosure.

At 402, a sequence of optimization operations are orchestrated by the supervisor agent 208.

In one or more embodiments, the supervisor agent 208 acts as an orchestrator and is trained to oversee the flow of information and direct the execution of tasks across the plurality of AI agents. The supervisor agent 208 is equipped with coordination capabilities that allow it to manage the interdependence between agents, monitor their progress, and adjust task sequences as needed to optimize overall system 106 performance.

In one or more embodiments, each AI agent of the plurality of AI agents is configured to perform specific optimization-related operations, with each agent specializing in a distinct aspect of the overall process. The specialization of each agent enables that the optimization process is broken down into manageable tasks, allowing for a more efficient and targeted approach. Each agent is equipped with tailored capabilities and algorithms suited to its assigned function.

In one or more embodiments, the supervisor agent 208 is configured to receive the process documents 102 via an interface. Upon receiving the process documents 102, the supervisor agent 208 orchestrates sequential interactions between the plurality of AI agents to generate and validate the optimization solutions.

In one or more embodiments, the supervisor agent 208 is also configured to verify intermediate outputs at each processing stage of the plurality of AI agents. By performing the verification, the supervisor agent 208 ensures that the outputs produced by each AI agent are consistent with the expected results and meet the required standards. This step allows for the identification of any discrepancies or errors early in the process, enabling prompt adjustments to be made before progressing to the next stage.

In one or more embodiments, the supervisor agent 208 is further configured to present the intermediate outputs via the interface for optimal human validation. As the optimization process progresses, the supervisor agent 208 displays the intermediate outputs generated by the plurality of AI agents, including identification of optimization areas, problem formulations, generated code, and potential solutions, allowing the users to review, assess, and validate the outputs at each critical stage.

The supervisor agent 208 may receive human feedback, which can include modifications to several aspects of the process. The modifications may involve changes to the identified optimization domains, such as refining or broadening the areas of focus based on user expertise or domain knowledge. Additionally, users can provide feedback on the optimization problem specifications, adjusting key parameters such as decision variables, objective functions, or constraints to better reflect the actual operational conditions or business goals.

At 404, the domain identifier and prompt generation agent 210 analyzes the input process documentation to identify optimization domains with corresponding optimization rationales.

Upon receiving the process documentation, the domain identifier and prompt generation agent 210 processes the text and extracts key information relevant to the optimization task. The LLM, which is capable of understanding and interpreting natural language, is utilized by the domain identifier and prompt generation agent 210 to identify one or more optimization domains.

Additionally, the domain identifier and prompt generation agent 210 works to identify the corresponding optimization rationales, which provide the reasoning behind selecting certain domains for optimization. This can include identifying inefficiencies, bottlenecks, or areas where resource allocation could be improved.

In one or more embodiments, the domain identifier and prompt generation agent 210 is enhanced with a prompt library that comprises a collection of domain-specific optimization prompts. The prompt library is designed to cover a wide range of process domains, ensuring that the domain identifier and prompt generation agent 210 can tailor its analysis to the specific context of the input process documentation. Upon receiving the process documentation, the domain identifier and prompt generation agent 210 first analyzes the content to identify the underlying process domain, such as manufacturing, supply chain, healthcare, or finance. Based on the determined process domain, the domain identifier and prompt generation agent 210 retrieves the corresponding domain-specific optimization prompt from the prompt library.

An exemplary embodiment of the prompt library is implemented as a structured repository containing a diverse collection of domain-specific optimization prompts. Each prompt in the library is designed to address the unique characteristics and optimization challenges of a particular process domain. For example, the library may include dedicated prompts for industries such as manufacturing, supply chain management, healthcare, finance, logistics, and customer service.

An exemplary embodiment of the domain identifier and prompt generation agent 210 handling a wide range of process domains involves a scalable and adaptive framework that enables domain-specific optimization analysis across various industries and operational environments. The domain identifier and prompt generation agent 210 is equipped with intelligent domain classification capabilities and a dynamic prompt library that supports optimization across diverse process domains such as manufacturing, supply chain management, healthcare, finance, logistics, retail, customer service, energy management, and software development.

In one or more embodiments, the domain-specific prompt is carefully crafted to include targeted instructions and context-relevant parameters that guide the subsequent analysis. The domain identifier and prompt generation agent 210 then transmits both the retrieved prompt and the original input process documentation to the LLM. The LLM processes the combined input, leveraging its advanced natural language understanding capabilities to perform an in-depth analysis of the process documentation in the context provided by the domain-specific prompt.

Following the LLM's analysis, the domain identifier and prompt generation agent 210 parses the responses to extract detailed information regarding potential optimization domains and the associated rationales. The rationales may include insights on inefficiencies, bottlenecks, or areas where improvements could yield significant benefits. By integrating a domain-specific prompt library, the domain identifier and prompt generation agent 210 enhances the precision of the optimization domain identification process also confirms that the extracted insights are both relevant and actionable for the targeted process area.

At 406, the formulator agent 212 generates dynamic prompts and generates optimization problem specifications comprising sets, parameters, decision variables, objective functions, and constraints based on the identified optimization domains and dynamic prompt.

In one or more embodiments, the formulator agent 212 receives the identified optimization domains and corresponding optimization rationales from the domain identifier and prompt generation agent 210. Upon receiving this information, the formulator agent 212 analyzes the characteristics of each optimization domain and translates them into a structured mathematical representation.

In some non-limiting embodiments, sets are the fundamental components of the optimization model, representing the elements over which decisions are made, such as time periods, resources, or process stages. Parameters are fixed numerical values that define the constraints and relationships in the model, such as resource availability, processing times, cost coefficients, and capacity limits. Decision variables are the variables that the optimization model seeks to determine, such as production levels, workforce allocation, or inventory quantities. These variables represent the choices available within the optimization framework. Objective functions are the mathematical expressions that define the optimization goals, such as minimizing costs, maximizing efficiency, improving throughput, or reducing waste. Constraints are the conditions that must be satisfied within the optimization problem, such as budget limitations, capacity restrictions, regulatory requirements, and time constraints.

In one or more embodiments, the formulator agent 212 receives the identified optimization domains and systematically extracts key optimization elements essential for problem formulation. The elements include sets, which define the fundamental components of the optimization model, such as time periods, resource groups, or process categories; parameters, which represent fixed numerical values derived from the input process documentation, such as capacity limits, cost coefficients, or operational thresholds; decision variables, which influence the optimization outcomes and encapsulate adjustable factors like production levels, staffing allocations, or scheduling decisions; objective functions, which define the optimization goals, such as minimizing costs, maximizing throughput, or enhancing resource utilization; and constraints, which impose limitations on the solution space, ensuring feasibility based on regulatory requirements, resource availability, or predefined business rules.

After extracting the elements, the formulator agent 212 determines the optimization type by analyzing the mathematical structure of the objective functions and the constraints. For instance, if the objective function and constraints are linear, the problem may be classified as a linear programming (LP) problem. If the constraints involve integer decision variables, it may be categorized as integer programming (IP), and if the optimization involves nonlinear relationships, it may fall under nonlinear programming (NLP). Additionally, the formulator agent 212 assesses whether the problem requires deterministic or stochastic optimization based on the presence of uncertainties in the process data.

Based on the determined optimization type, the formulator agent 212 selects an appropriate optimization solver from a set of available solvers. The selection may be based on factors such as the computational complexity of the problem, the required solution accuracy, and the processing time constraints. For instance, the solver may include commercial solvers such as, for example, Gurobi, CPLEX, and MOSEK, or open-source solvers such as GLPK, CBC, and SCIP, depending on the nature of the problem and constraints. The selected solver is then configured to execute the formulated optimization model, ensuring that the generated solution aligns with the identified optimization goals.

In one or more embodiments, the formulator agent 212 is further configured to validate the mathematical completeness of the optimization problem specifications to ensure that all required components sets, parameters, decision variables, objective functions, and constraints are correctly defined and logically coherent. This validation process includes checking for missing dependencies, ensuring that all decision variables are properly bound, and confirming that constraints do not conflict with one another, which could otherwise lead to infeasible solutions.

Additionally, the formulator agent 212 verifies consistency between constraints by analyzing their structural relationships. This involves detecting redundant, contradictory, or overly restrictive constraints that might unnecessarily limit the feasible region of the optimization problem. The formulator agent 212 may also assess the dimensional consistency of parameters and variables to prevent formulation errors, such as mismatched units or misaligned indexing in multi-dimensional constraints.

Upon successful validation, the formulator agent 212 generates a structured representation of the optimization problem in a format suitable for code generation. This structured representation may include a formalized mathematical model expressed in symbolic notation, a standardized schema for representing the problem in a declarative optimization modeling language (e.g., AMPL, Pyomo, or GAMS), or a structured data format such as JSON or XML, facilitating seamless transformation into executable code by the programmer agent 214. The structured representation ensures that the optimization problem can be efficiently parsed, translated into an appropriate programming framework, and executed using the selected optimization solver.

At 408, the optimization problem specifications are translated into executable optimization code by the programmer agent 214. The programmer agent 214 receives the structured representation of the optimization problem from the domain identifier and prompt generation agent 210 and maps the mathematical constructs such as sets, parameters, decision variables, objective functions, and constraints into a programming language or optimization modeling framework.

The programmer agent 214 is further configured to automatically select an appropriate programming environment based on the optimization type and solver requirements. For instance, if the optimization problem requires linear programming (LP), the programmer agent 214 may generate code in Python using PuLP or Gurobi, whereas for mixed-integer programming (MIP), it may utilize Pyomo or CPLEX. Similarly, for constraint programming or heuristic-based optimization, the programmer agent 214 may generate code compatible with frameworks like OR-Tools or MATLAB.

In one or more embodiments, the programmer agent 214 receives the optimization problem specifications and selects appropriate optimization libraries based on the selected optimization solver. The selection of libraries is determined by the optimization type, computational complexity, and solver compatibility, ensuring efficient execution.

The programmer agent 214 then generates executable optimization code by systematically structuring it into key components. First, problem initialization routines are created to set up the computational environment, including library imports and solver configurations. Next, variable declarations are generated in alignment with the decision variables defined in the optimization problem specifications. The programmer agent 214 then formulates the objective function, ensuring that its implementation correctly reflects the optimization goal. Subsequently, constraint definitions are incorporated, preserving mathematical consistency and logical coherence within the solution space. The final component of the generated code includes solver integration interfaces, allowing seamless execution of the optimization problem within the designated solver framework.

In one or more embodiments, once the code is generated, the programmer agent 214 performs automated verification and validation to ensure correctness. This includes syntax checks, structural validation against the problem specifications, and preliminary test runs using sample data to detect potential errors.

In one or more embodiments, the programmer agent 214 structures the executable optimization code to handle one or more of data input validation, solution feasibility checks, error recovery mechanisms, and solution output formatting.

The data input validation component ensures that all input parameters, including sets, decision variables, constraints, and objective functions, conform to the expected format, range, and data type. The programmer agent 214 embeds automated checks to detect missing or inconsistent data, triggering corrective prompts or predefined fallback values as needed.

The solution feasibility checks involve incorporating verification routines to assess whether the computed optimization results satisfy all defined constraints and boundary conditions. If the solver returns an infeasible or suboptimal solution, the code includes mechanisms for constraint relaxation or parameter adjustments to refine the solution iteratively.

The error recovery mechanisms handle unexpected execution failures, such as solver convergence issues, numerical instability, or computational resource constraints. The programmer agent 214 integrates structured exception handling, logging mechanisms, and automated retries with adjusted parameters to enhance fault tolerance and ensure a higher probability of obtaining an optimal solution.

Finally, the solution output formatting ensures that the computed optimization results are structured in a readable and interpretable manner. The programmer agent 214 formats the output to align with predefined reporting standards, visual representation requirements, or integration with downstream decision-making systems.

At 410, optimization solutions are validated, and constraint adjustments are implemented by the evaluator agent 216.

In one or more embodiments, the evaluator agent 216 executes the executable optimization code within a controlled environment to ensure stability and reproducibility of the optimization process. During execution, the evaluator agent 216 continuously monitors solution convergence by tracking key performance indicators such as objective function values, constraint satisfaction levels, and computational efficiency. If the solution fails to converge within predefined thresholds, the evaluator agent 216 analyzes the underlying causes, which may include infeasibility due to conflicting constraints, numerical instability, or suboptimal solver configurations.

Upon detecting infeasibility conditions, the evaluator agent 216 implements iterative constraint adjustments by dynamically modifying constraint boundaries, introducing relaxation factors, or restructuring penalty functions to guide the solution toward feasibility. These adjustments are informed by sensitivity analysis techniques, which assess how minor changes in constraints impact solution viability.

In one or more embodiments, implementing the iterative constraint adjustments includes a detailed process of identifying specific constraints that are causing infeasibility in the optimization process. The evaluator agent 216 analyzes the current optimization solution and identifies constraints that either conflict with other constraints or prevent the solution from reaching feasible regions of the solution space. This identification process may involve performing sensitivity analysis, where the impact of small changes in constraint parameters is evaluated to pinpoint the most influential constraints.

Once the infeasible constraints are identified, the evaluator agent 216 modifies the boundaries of these constraints within acceptable ranges, ensuring that the adjustments do not violate the overall optimization goals or predefined limits. The adjusted constraints are then integrated into the executable optimization code, and the code is re-executed with the updated constraint parameters.

After each adjustment iteration, the evaluator agent 216 verifies solution feasibility by re-assessing the satisfaction of all constraints. The feasibility check includes validating that the newly adjusted constraints do not introduce further infeasibility and that the solution converges toward an optimal solution. This process continues iteratively, with the evaluator agent 216 adjusting constraints as necessary and re-executing the optimization code, until a feasible solution that satisfies all constraints is found or the solution space is exhausted.

At 412, the supervisor agent 208 verifies intermediate outputs at each processing stage and outputs the validated optimization solutions via the interface.

In one or more embodiments, the supervisor agent 208 receives the final, validated optimization results from the evaluator agent 216 and formats these results for clear presentation and integration into downstream applications or user workflows. The supervisor agent 208 may transform the solutions into various formats, such as graphical dashboards, structured reports (e.g., PDF, Excel, or JSON), or real-time notifications, depending on user preferences and system requirements. Additionally, the supervisor agent 208 is designed to support interactive visualizations, enabling the user to drill down into solution details, review constraint adjustments, and assess the performance metrics associated with the optimization outcomes.

The present disclosure provides a method and system that systematically improves business processes by following a structured approach. The system first identifies improvement areas in an existing process by analyzing relevant documentation and extracting optimization domains. Next, it employs dynamic prompt generation to frame the problem effectively and constructs formal optimization problem specifications. Once formulated, the system translates these specifications into executable optimization code. The generated code is then executed and validated, which ensures solution correctness and compliance with optimization constraints. Finally, the system performs feasibility analysis to refine constraints iteratively and provide actionable recommendations. By following the structured approach, the system streamlines complex optimization tasks, integrates domain-specific reasoning, and facilitates seamless adoption of Generative AI for business users, accelerating AI-driven decision-making in enterprise environments.

The present disclosure offers a significant technical advantage by enabling automatic correction of executable optimization code and iterative refinement of optimization solutions. The system autonomously detects inconsistencies in the formulated problem, adjusts constraints, and modifies optimization models to ensure feasibility. Using the multi-agent AI-based approach, the system eliminates the need for manual intervention in debugging and fine-tuning processes, thereby improving computational efficiency. Moreover, the system conducts a thorough feasibility analysis, refining optimization recommendations and ensuring that solutions align with real-world constraints. This significantly reduces the time and effort required for debugging, validation, and fine-tuning, enhancing overall system performance and reliability.

A key technical advantage of the disclosed multi-agent AI-based optimization framework is its ability to iteratively refine optimization solutions to enhance accuracy and efficiency. Traditional optimization methods often struggle with infeasible solutions due to rigid constraints, requiring manual intervention for adjustments. The disclosed system overcomes these limitations by automatically detecting infeasibility conditions, analyzes constraint violations, and iteratively modifies the optimization parameters to achieve a feasible solution. This dynamic refinement mechanism ensures faster convergence to an optimal solution, reduces computational overhead, and enhances the reliability of the optimization process by eliminating the need for manual fine-tuning.

Another technical advantage of the present disclosure is its ability to enhance the explainability and transparency of the optimization process. Unlike conventional AI-driven optimization techniques, which often function as “black-box” systems, the disclosed system integrates decision-tracking and justification mechanisms at every stage. The system ensures that domain identification, problem formulation, constraint adjustments, and solution validation are accompanied by detailed reasoning generated by the system. By providing step-by-step explanations of the optimization process, the system enhances trustworthiness, and enables business users to understand, validate, and refine AI-generated recommendations with minimal reliance on external expertise.

The present disclosure enhances trustworthiness among users by incorporating reasoning at every stage of the optimization process. By providing clear explanations from the identification of the optimization domain to the derivation of the optimal solution, the multi-agent AI based optimization framework enables transparency and interpretability. This not only builds user confidence in the generated solutions but also fosters greater adoption of AI-driven optimization in business environments.

The present disclosure is advantageous in that it is domain-agnostic, enabling its application across a wide range of industries and optimization scenarios. By leveraging a flexible and adaptable framework, the system can process diverse types of process documentation, identify optimization opportunities, and generate tailored solutions without being restricted to a specific domain.

The present disclosure is also advantageous in that it is user-agnostic, allowing it to generate optimization solutions without requiring user intervention. By leveraging an autonomous multi-agent AI based optimization framework, the system can independently analyze process documentation, identify optimization domains, formulate problem specifications, generate executable code, and validate solutions. This eliminates the need for manual input, reducing dependency on domain experts and ensuring consistent, efficient, and unbiased optimization outcomes across various applications.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for automated process optimization, comprising:
a processor;
a memory storing instructions that, when executed by the processor, cause the system to implement:
a multi-agent artificial intelligence (AI) based optimization framework comprising:
a plurality of AI agents, wherein each AI agent of the plurality of AI agents is configured to perform specific optimization-related operations, the plurality of AI agents comprising:
a domain identifier and prompt generation agent configured to interface with a large language model (LLM) to analyze input process documentation and identify one or more optimization domains with corresponding optimization rationales;
a formulator agent configured to generate one or more optimization problem specifications comprising sets, parameters, decision variables, objective functions, and constraints based on the identified optimization domains;
a programmer agent configured to translate the optimization problem specifications into executable optimization code;
an evaluator agent configured to validate optimization solutions and implement constraint adjustments;
a supervisor agent operatively coupled to the plurality of AI agents, wherein the supervisor agent is configured to:
receive the input process documentation via an interface;
orchestrate sequential interactions between the plurality of AI agents to generate and validate the optimization solutions;
verify intermediate outputs at each processing stage; and
output the validated optimization solutions via the interface.

2. The system of claim 1, wherein the domain identifier and prompt generation agent is configured to:
maintain a prompt library comprising domain-specific optimization prompts;
identify a process domain from the input process documentation;
retrieve a domain-specific optimization prompt from the prompt library based on the identified process domain;
transmit the domain-specific optimization prompt and the input process documentation to the LLM; and
parse responses from the LLM to extract the identified optimization domains and the corresponding optimization rationales.

3. The system of claim 1, wherein the formulator agent is configured to:
receive the identified optimization domains;
extract optimization elements comprising the sets required for problem formulation, the parameters from the input process documentation, the decision variables affecting optimization outcomes, the objective functions defining optimization goals, and the constraints limiting solution space;
determine an optimization type based on the objective functions and the constraints; and
select an optimization solver based on the determined optimization type.

4. The system of claim 1, wherein the formulator agent is further configured to:
validate mathematical completeness of the optimization problem specifications;
verify consistency between the constraints; and
generate a structured representation of an optimization problem suitable for code generation.

5. The system of claim 1, wherein the programmer agent is configured to:
receive the optimization problem specifications;
select optimization libraries based on the selected optimization solver;
generate the executable optimization code comprising problem initialization routines, variable declarations aligned with the decision variables, the objective function implementations, constraint definitions, and solver integration interfaces; and
verify syntactic correctness of the executable optimization code.

6. The system of claim 5, wherein the programmer agent is further configured to structure the executable optimization code to handle one or more of data input validation, solution feasibility checks, error recovery mechanisms, and solution output formatting.

7. The system of claim 1, wherein the evaluator agent is configured to:
execute the executable optimization code in a controlled environment;
monitor solution convergence during execution;
detect infeasibility conditions in an optimization process;
implement iterative constraint adjustments to resolve detected infeasibilities; and
validate final optimization solutions against defined performance metrics.

8. The system of claim 7, wherein implementing the iterative constraint adjustments comprises:
identifying specific constraints causing infeasibility;
modifying constraint boundaries within acceptable ranges;
re-executing the executable optimization code with adjusted constraints; and
verifying solution feasibility after each adjustment iteration.

9. The system of claim 1, wherein the supervisor agent is further configured to:
present the intermediate outputs via the interface for optional human validation;
receive human feedback comprising modifications to one or more of the identified optimization domains, the optimization problem specifications, the executable optimization code, and the constraint adjustments; and
propagate the modifications to subsequent processing stages.

10. The system of claim 9, wherein incorporating the human feedback comprises:
receiving modifications to one or more of the identified optimization domains, the optimization problem specifications, the executable optimization code, and the constraint adjustments; and
propagating the modifications to subsequent processing stages.

11. A method for automated process optimization using a multi-agent artificial intelligence (AI) based optimization framework, the method comprising:
receiving, by a processor, input process documentation via an interface;
orchestrating, by a supervisor agent, a sequence of optimization operations comprising:
analyzing, by an identification agent interfacing with a large language model (LLM), the input process documentation to identify optimization domains with corresponding optimization rationales;
generating, by a formulator agent, optimization problem specifications comprising sets, parameters, decision variables, objective functions, and constraints based on the identified optimization domains;
translating, by a programmer agent, the optimization problem specifications into executable optimization code;
validating, by an evaluator agent, optimization solutions and implementing constraint adjustments;
verifying, by the supervisor agent, intermediate outputs at each processing stage; and
outputting the validated optimization solutions via the interface.

12. The method of claim 11, wherein the domain identifier and prompt generation agent comprises:
maintaining a prompt library comprising domain-specific optimization prompts;
identifying a process domain from the input process documentation;
retrieving a domain-specific optimization prompt from the prompt library based on the identified process domain;
transmitting the domain-specific optimization prompt and the input process documentation to the LLM; and
parsing responses from the LLM to extract the identified optimization domains and the corresponding optimization rationales.

13. The method of claim 11, wherein generating the optimization problem specifications comprises:
extracting optimization elements comprising the sets, the parameters, the decision variables, the objective functions, and the constraints;
determining an optimization type based on the objective functions and the constraints;
selecting an optimization solver based on the determined optimization type; and
validating mathematical completeness of the optimization problem specifications.

14. The method of claim 11, wherein translating the optimization problem specifications comprises:
selecting optimization libraries based on the selected optimization solver;
generating the executable optimization code comprising problem initialization routines, variable declarations, objective function implementations, constraint definitions, and solver integration interfaces; and
verifying syntactic correctness of the executable optimization code.

15. The method of claim 11, wherein validating the optimization solutions comprises:
executing the executable optimization code in a controlled environment;
monitoring solution convergence during execution;
detecting infeasibility conditions in an optimization process; implementing iterative constraint adjustments to resolve detected infeasibilities; and
validating final optimization solutions against defined performance metrics.

16. The method of claim 15, wherein implementing the iterative constraint adjustments comprises:
identifying specific constraints causing infeasibility; modifying constraint boundaries within acceptable ranges;
re-executing the executable optimization code with adjusted constraints; and
verifying solution feasibility after each adjustment iteration.

17. The method of claim 11, wherein verifying the intermediate outputs comprises:
presenting the intermediate outputs via the interface for optional human validation;
receiving human feedback comprising modifications to one or more of the identified optimization domains, the optimization problem specifications, the executable optimization code, and the constraint adjustments; and
propagating the modifications to subsequent processing stages.
